(19) United States
(12) Patent Application Publication
(10) Pub. No.: US 2019/0042139 A1
(43) Pub. Date: Feb. 7, 2019

(54) MOVING AVERAGE VALID CONTENT ON SSD

(71) Applicant: Intel Corporation, Santa Clara, CA (US)

(72) Inventors: Brennan Watt, Folsom, CA (US); Joseph Tarango, Longmont, CO (US); Swetha Natham, Folsom, CA (US)

(21) Appl. No.: 16/117,157

(22) Filed: Aug. 30, 2018

(51) Int. Cl. G06F 3/06

(52) U.S. Cl. CPC G06F 3/0647; G06F 3/0673; G06F 3/0631; G06F 3/0604

(57) ABSTRACT

An embodiment of a semiconductor apparatus may include technology to track defect information related to a persistent storage media, and determine a best next candidate for background clean-up of the persistent storage media based on the tracked defect information. Other embodiments are disclosed and claimed.

### TECHNICAL FIELD

Embodiments generally relate to storage systems. More particularly, embodiments relate to Moving Average Valid Content (MAVc) on Solid State Drives (SSD).

### BACKGROUND

For some types of persistent storage, the media may be erased before being rewritten. For example, some SSDs may utilize NAND flash memory media where old data gets erased data before writing new data to the same location. Some SSDs may provide background clean-up technology, which is sometimes referred to as garbage collection (GC) or background data refresh (BDR).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor apparatus according to an embodiment;

FIGS. 3A to 3C are flowcharts of an example of a method of controlling storage according to an embodiment;

FIG. 4 is a flowchart of an example of a method of managing storage according to an embodiment;

FIG. 5 is a block diagram of an example of a storage system according to an embodiment;

FIG. 6 is a flowchart of an example of a method of determining MAVc based on band size according to an embodiment;

FIGS. 7A to 7B are illustrative graphs of available blocks versus time according to an embodiment;

FIG. 8 is a block diagram of an example of a computing system according to an embodiment; and

FIG. 9 is a block diagram of an example of a SSD according to an embodiment.

### DESCRIPTION OF EMBODIMENTS

Various embodiments described herein may include a memory component and/or an interface to a memory component. Such memory components may include volatile and/or nonvolatile memory. Nonvolatile memory may be a storage medium that does not require power to maintain the state of data stored by the medium. In one embodiment, the memory device may include a block addressable memory device, such as those based on NAND or NOR technologies. A memory device may also include future generation nonvolatile devices, such as a three-dimensional (3D) crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory may be a storage medium that requires power to maintain the state of data stored by the medium. Non-limiting examples of volatile memory may include various types of random access memory (RAM), such as dynamic RAM (DRAM) or static RAM (SRAM). One particular type of DRAM that may be used in a memory module is synchronous dynamic RAM (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

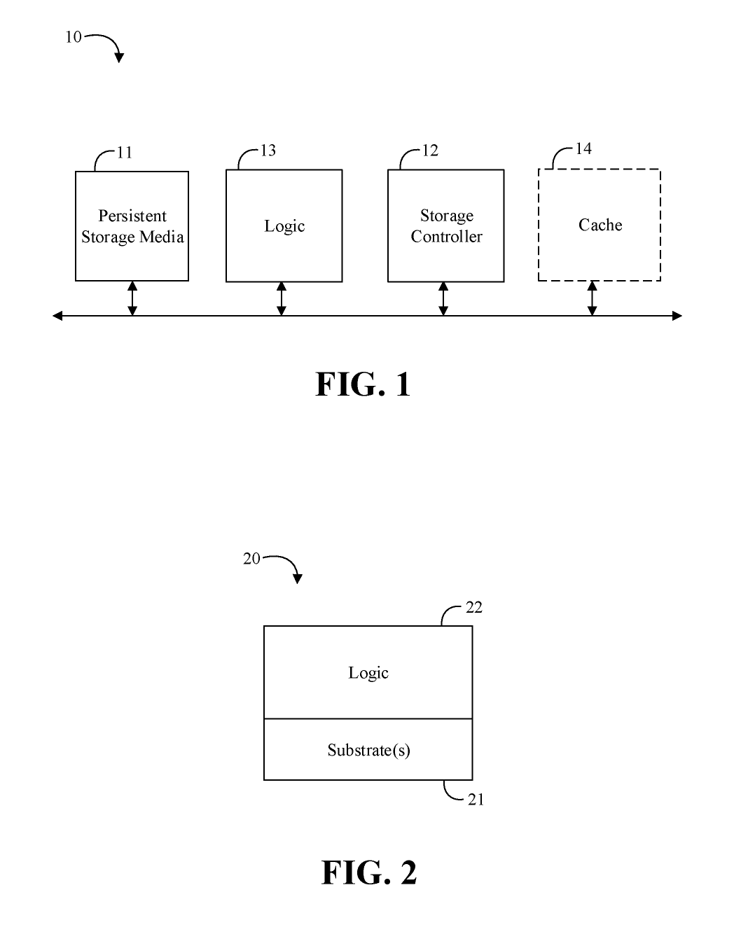

Turning now to FIG. 1, an embodiment of an electronic processing system 10 may include persistent storage media 11, and a storage controller 12 communicatively coupled to the persistent storage media 11. The storage controller 12 may include logic 13 to track defect information related to the persistent storage media 11, and determine a best next candidate for background clean-up of the persistent storage media 11 based on the tracked defect information. Some embodiments of the system 10 may further include a cache 14, and the logic 13 may be configured to store the tracked defect information in the cache 14. In some embodiments, the logic 13 may be further configured to determine average invalid content information for the persistent storage media 11, determine free space information for the persistent storage media 11, determine average valid content information for the persistent storage media 11 based at least in part on the tracked defect information, and determine the best next candidate for background clean-up of the persistent storage media 11 based on the determined average invalid content information, the determined free space information, and the determined average valid content information. For example, the logic 13 may be configured to determine the best next candidate for background clean-up of the persistent storage media based on a ratio of the determined average invalid content information to the determined average valid content information.

In some embodiments, the logic 13 may be further configured to allocate resources between a host and the background clean-up based on the determined average invalid content information, the determined free space information, and the determined average valid content information. The logic 13 may additionally, or alternatively, be configured to select the determined best next candidate as a reclaim unit for background clean-up, and move content from the reclaim unit to a new destination on the persistent storage media 11. In any of the embodiments herein, the persistent storage media 11 may include a SSD. In some embodiments, the logic 13 may be located in, or co-located with, various components, including the storage controller 12 (e.g., on a same die).

Embodiments of each of the above persistent storage media 11, storage controller 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the storage controller 12 may include a general purpose controller, a special purpose controller, a micro-controller, a processor, a central processor unit (CPU), a graphics processor unit (GPU), etc.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the persistent storage media 11, or other system memory may store a set of instructions which when executed by the storage controller 12 cause the system 10 to implement one or more components, features, or aspects of the system 10 (e.g., the logic 13, tracking defect information, determining the best next candidate for background clean-up, etc.).

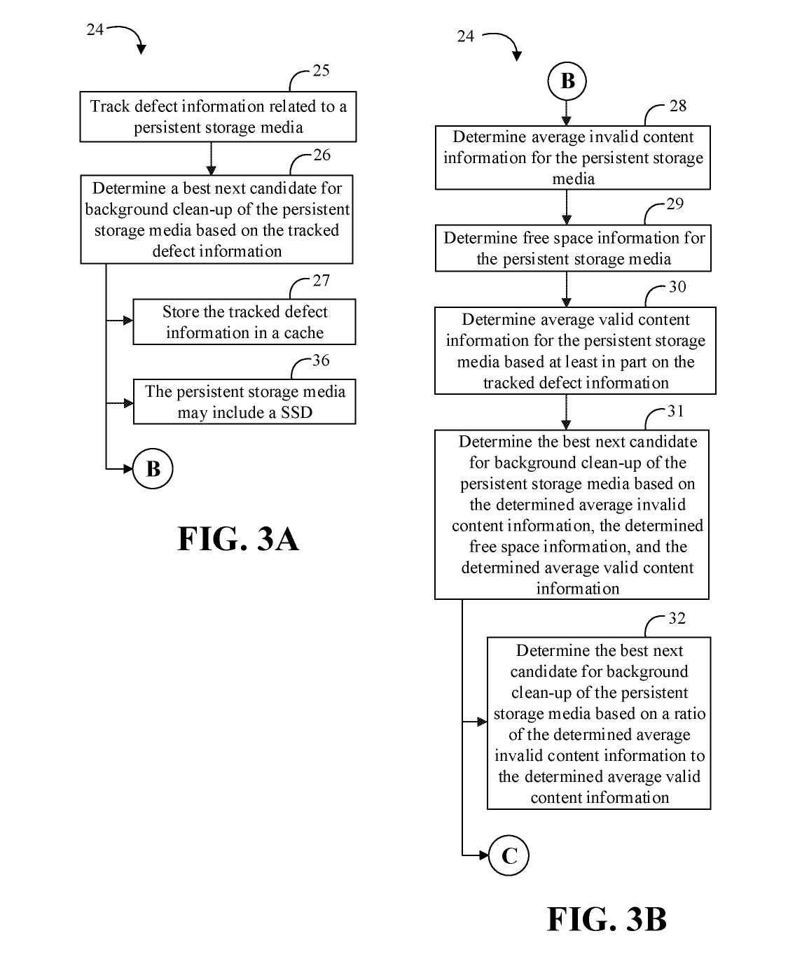

Turning now to FIG. 2, an embodiment of a semiconductor apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to track defect information related to a persistent storage media, and determine a best next candidate for background clean-up of the persistent storage media based on the tracked defect information. In some embodiments, the logic 22 may be configured to store the tracked defect information in a cache. In some embodiments, the logic 22 may be further configured to determine average invalid content information for the persistent storage media, determine free space information for the persistent storage media, determine average valid content information for the persistent storage media based at least in part on the tracked defect information, and determine the best next candidate for background clean-up of the persistent storage media based on the determined average invalid content information, the determined free space information, and the determined average valid content information. For example, the logic 22 may be configured to determine the best next candidate for background clean-up of the persistent storage media based on a ratio of the determined average invalid content information to the determined average valid content information.

In some embodiments, the logic 22 may be further configured to allocate resources between a host and the background clean-up based on the determined average invalid content information, the determined free space information, and the determined average valid content information. The logic 22 may additionally, or alternatively, be configured to select the determined best next candidate as a reclaim unit for background clean-up, and move content from the reclaim unit to a new destination on the persistent storage media. In any of the embodiments herein, the persistent storage media may include a SSD. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

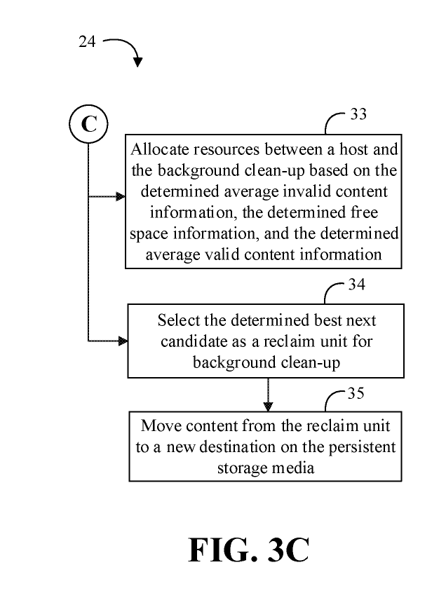

The apparatus 20 may implement one or more aspects of the method 24 (FIGS. 3A to 3C), or any of the embodiments discussed herein. In some embodiments, the illustrated apparatus 20 may include the one or more substrates 21 (e.g., silicon, sapphire, gallium arsenide) and the logic 22 (e.g., transistor array and other integrated circuit/IC components) coupled to the substrate(s) 21. the logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. the logic 22 may also be considered to include an epitaxial layer that is grown on an initial wafer of the substrate(s) 21.

Turning now to FIGS. 3A to 3C, an embodiment of a method 24 of controlling storage may include tracking defect information related to a persistent storage media at block 25, and determining a best next candidate for background clean-up of the persistent storage media based on the tracked defect information at block 26. The method 24 may also include storing the tracked defect information in a cache at block 27. Some embodiments of the method 24 may further include determining average invalid content information for the persistent storage media at block 28, determining free space information for the persistent storage media at block 29, determining average valid content information for the persistent storage media based at least in part on the tracked defect information at block 30, and determining the best next candidate for background clean-up of the persistent storage media based on the determined average invalid content information, the determined free space information, and the determined average valid content information at block 31. For example, the method 24 may include determining the best next candidate for background clean-up of the persistent storage media based on a ratio of the determined average invalid content information to the determined average valid content information at block 32.

Some embodiments of the method 24 may further include allocating resources between a host and the background clean-up based on the determined average invalid content information, the determined free space information, and the determined average valid content information at block 33. The method 24 may also include selecting the determined best next candidate as a reclaim unit for background clean-up at block 34, and moving content from the reclaim unit to a new destination on the persistent storage media at block 35. In any of the embodiments herein, the persistent storage media may include a SSD at block 36.

Embodiments of the method 24 may be implemented in a system, apparatus, computer, device, etc., for example, such as those described herein. More particularly, hardware implementations of the method 24 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 24 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 24 may be implemented on a computer readable medium as described in connection with Examples 23 to 29 below. Embodiments or portions of the method 24 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide technology for moving average valid content (MAVc) on SSDs. In SSDs, media health can vary based on manufacturing, environment, etc., and normal wear over time. Portions of the media may be represented as defects. Depending on the generation of media, defects can be numerous or scarce, impacting the SSD operation. Without accounting for these defects, the actual available space for user content will introduce entropy into a conventional garbage collection (GC) system. For example, the magnitude of defects in the storage system may be directly observed in the form of variance in bandwidth and uniformity of memory operations, which may be highly undesirable in cloud computing environments. Cloud computing aspires to provide scalable architecture, resource sharing, quality of service, and bandwidth guarantees without the overhead of ownership of the data center. In some conventional cloud computing systems, unpredictable behavior of bandwidth and uniformity may result in customer observed system challenges. Some embodiments may advantageously improve one or more aspects of a GC system based on, for example, valid content, invalid content, and reclaim potential. For example, some embodiments may provide a SSD storage system for high performance cloud computing applications with more uniform performance, more predictable bandwidth, longer endurance of the SSD media, reduced power consumption, improved reliability, availability, and serviceability (RAS), and/or simplified administration of service level agreements.

Some embodiments may advantageously utilize caching to keep track of defects and may apply the tracked defects to determine a next best candidate to maintain improved or optimized performance based on the media state. Some embodiments may also decrease impact of non-uniformity as the drive wears. By tracking defects in addition to valid content, some embodiments may better represent the actual amount of free space to be reclaimed by the GC process, and more optimal reclaim unit selections may be determined. For example, some embodiments may count defective locations as valid content, which may make more defective reclaim units appear more desirable, increasing the likelihood of more optimal selections for the reclaim unit. Advantageously, making improved or more optimal reclaim unit decisions may enable the GC technology to not work as hard, to consume fewer resources, and to bring up overall system throughput. Some embodiments may allow end users, administrators, customers, etc. to maintain more consistent performance during GC, particularly as the SSD ages or near end of life for the SSD when there may be more defective media locations.

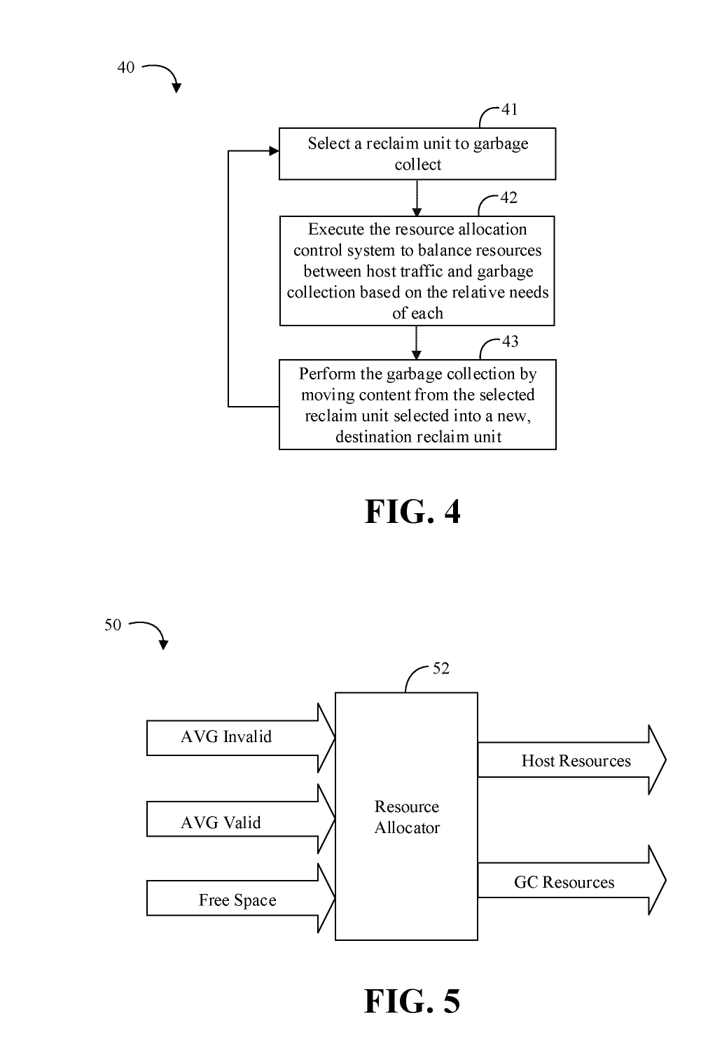

Turning now to FIG. 4, an embodiment of a method 40 of managing storage may include selecting a reclaim unit to garbage collect at block 41. For example, the reclaim unit may be selected based on merit formula(s) involving an amount of free space that will be recovered. Advantageously, some embodiments may improve the determination of the best next candidate reclaim unit based on tracked defect information (e.g., as described in detail herein). The method 40 may then include executing the resource allocation control system to balance resources between host traffic and garbage collection based on the relative needs of each at block 42, and performing the garbage collection by moving content from the selected reclaim unit selected into a new, destination reclaim unit at block 43, and then returning to block 41 to repeat the storage management process. The method 40 is an illustrative example of a high-level garbage collection and associated resource allocation flow which may be suitable for many systems/devices. Specific implementation may vary depending on the particular application.

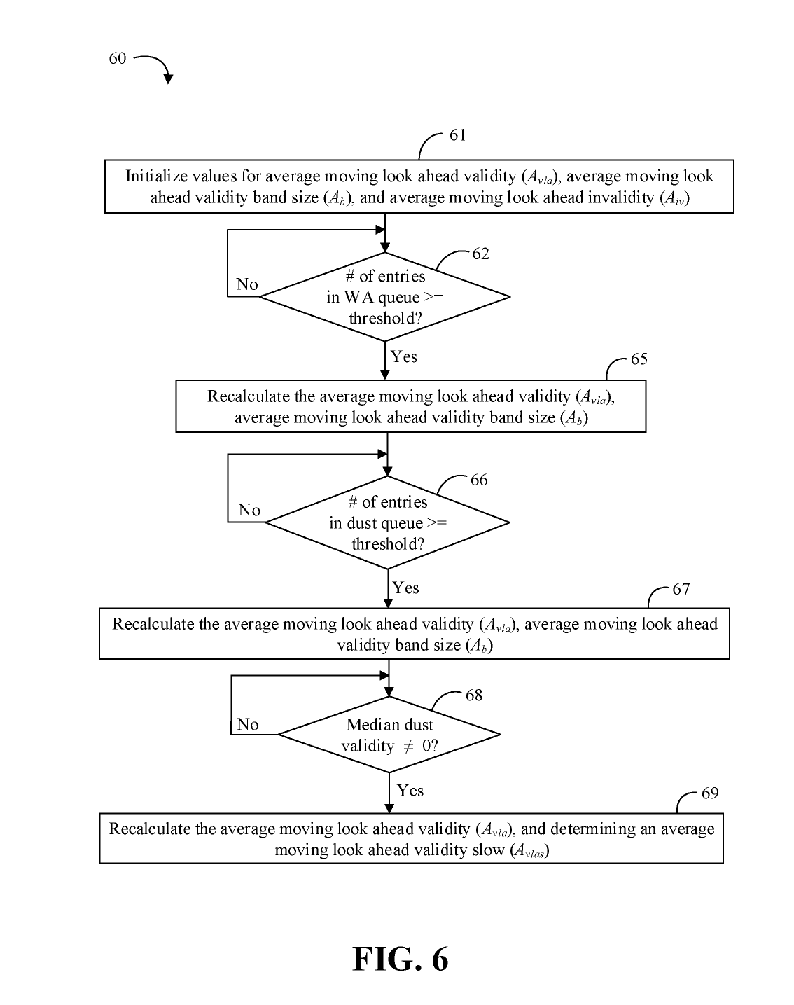

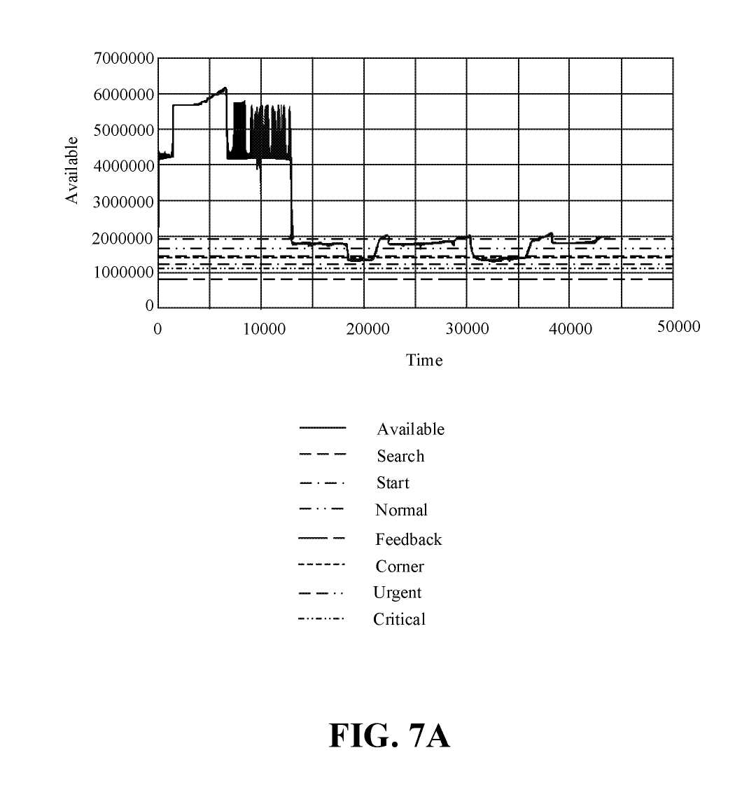

Turning now to FIG. 5, an embodiment of a storage system 50 may include a resource allocator 52 configured to receive average invalid content information, average valid content information, and free space information as inputs, to allocate resource information between host operations and GC operations, and to provide the allocated host resource information and the allocated GC resource information as outputs. For example, the resource allocator 52 may include logic and/or other technology to implement one or more aspects of the method 24 (FIGS. 3A to 3C), the method 40 (FIG. 4), and/or the method 60 (FIG. 6).

Embodiments of the resource allocator 52, and other components of the storage system 50, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

A reclaim unit may correspond to the smallest unit of media that can be erased and garbage collected. Valid content may correspond to the most recent copy on media of a particular piece of user data on the device. Valid content must be moved when garbage collection is performed. Invalid content may correspond to the opposite of valid data (e.g., stale user data, internal device meta data, etc.). Invalid content does not need to be moved by garbage collection and may become the free space that may be reclaimed through the process of garbage collection. A defective block may correspond to a piece of media that has been unmapped by the device and cannot be used. Defective blocks may be ignored by conventional GC technology because the defective blocks do not contain valid content, and because the defective blocks cannot be reclaimed as free space through GC processes.

Advantageously, some embodiments of the resource allocator may utilize tracked defect information to improve GC technology. For example, the resource allocator 52 may include technology to improve performance uniformity by allocating a consistent level of resources to host traffic and garbage collection. Some other GC systems may select a reclaim unit and/or allocate resources between the host and the GC system based on free space (e.g., available block) and average invalid content information (e.g., a ratio of empty content to total block set capacity) of the reclaim units being garbage collected, without taking the variability in defects within the reclaim unit into account. For example, average valid content of the reclaim units being garbage collected may have been approximated based on the typical reclaim unit size when completely healthy (e.g., no defects), which does not accurately reflect the media state. In some applications, disregarding defects may lead to less accurate tracking of valid versus invalid content, particularly as the SSD ages, and may also result in significant variance in peak performance and uniformity. Some embodiments may advantageously provide an explicit input of average valid content of the reclaim units being garbage collected to the resource allocator 52 (e.g., see FIG. 5), which includes more accurate information related to defects in the reclaim units.

Some embodiments may allow the current valid content to be taken into account in conjunction with invalid content and defective blocks, providing an improved adaptive garbage selection technique to choose an improved or optimized candidate given the current state of the media. Utilizing the current valid content advantageously enables greater visibility into the amount of valid content that must be moved by garbage collection in order to recover the invalid content as free space. Rather than selecting reclaim units based on the absolute value of invalid content, some embodiment may select reclaim units based on the ratio of invalid content to valid content, where the larger ratio may indicate the better reclaim unit candidate.

Turning now to FIG. 6, an embodiment of a method 60 of determining MAVc based on band size may assume that queues are an ordered list from most recent to least recent candidate, queues are organized as an ordered first in first out (FIFO), and a minimum queue size is eight (8) and a maximum queue size is ten (10) (e.g., system in progress or pending candidates). In connection with Equations 1 through 13 below, a smallest element at which a block can be erased may be referred to as an erase block (EB) and the corresponding element for programming may be referred to as a program block (PB). To relocate data from one programed blocked to an erased block for the state change, the element may be referred to as a read block (RB). The granularity of the elements can be of disjoint size so the interaction between the blocks are staged such that the greatest common denomination is the transitioning set (TS) called a band. A feature of a band is that the set consists of concurrent EBs.

The size of nil content may be referred to as invalidity and the occupied blocks may be referred to as validity. To categorize the rates of movement directionally from invalid and valid content consist of transitions set of {{RB, EB}, {RB, PB}, {EB, PB}}. The rate of these transitions may be tracked over a time series per band. The characteristic of program duration may be a second separating criterion for cases to determine the collections. The collections may be categorized in manner that is related to the inherent rates. The ceiling of the rate function may be referred to as write amplification (WA) and the floor may be referred to as dust (DU). Other events to maintain product imperatives and policies may accelerate the criteria selection policy. Examples of these accelerations may include wear, media limitations, data refresh, and cell integrity due to accesses that trigger a forced relocation (FR).

To determine the concurrency rates, some embodiments may determine a potential concurrency and an actual concurrency. The potential concurrency relates to a perfect concurrency of PBs. Due to the inherent imperfections of media, the potential concurrency can be reduced based on the conditional state change of the block moving to defective. The state of no ability to use a PB may be referred to as a defective block (DB). The removal of the block decreases the potential concurrency based on the locality or sparse nature of the defects. To simplify the concurrency reduction, the potential concurrency nay be normalized at the smallest granularity such that summation of defects may be based on a linear concurrency from potential concurrency to nil, representing a concurrency model. The actual concurrency is mapped from the concurrency model to be additional criteria in the merit selection.

In the below formulas, the denoted variables may correspond to the following notations:
WAᵥ:=Write amplification validity
WA_{abs}:=Write amplification acutal band size
DUᵥ:=Dust validity
DU_{abs}:=Dust acutal band size
Qₛ^{WA}:=Active queue size of write amplification
Qₘₛ^{WA}:=Maximum queue size potential of write amplification
Qₛ^{DU}:=Active queue size of dust queue
Qₘₛ^{DU}:=Maximum queue size potential of dust queue
Aᵥₗₐ:=Average moving look ahead validity
Aᵥₗₐₛ:=Average moving look ahead validity slow
A_{b}:=Average moving look ahead validity band size
Aᵢᵥ:=Average moving look ahead invalidity
Aᵥₐₗ^{d}:=Average moving look ahead validity of dust
A_{b}^{d}:=Average moving look ahead validity band size
Aᵥₐₗ^{d}:=Average moving look ahead invalidity

Some embodiments of the method 60 may include initializing values for average moving look ahead validity (Aᵥₗₐ), average moving look ahead validity band size (A_{b}), and average moving look ahead invalidity (Aᵢᵥ) at block 61. For example, the variables may be initialized as follows:

$$\begin{matrix}{A}_{vla} = {A}_{vlas} = \frac{{\sum }_{1}^{{Q}_{s}^{WA}} {WA}_{v}}{{Q}_{s}^{WA}} & [ Eq . 1 ] \\ {A}_{b} = \frac{{\sum }_{1}^{{W}_{s}^{WA}} {WA}_{ab s}}{{Q}_{s}^{WA}} & [ Eq . 2 ] \\ {A}_{iv} = {A}_{b} - {A}_{vla} & [ Eq . 3 ]\end{matrix}$$

The method 60 may then include determining if the number of entries in a write amplification queue is greater than or equal to a threshold at block 62. If there are at least minimum queue size entries in write amplification queue, the method 60 may include recalculating the average moving look ahead validity (Aᵥₗₐ), average moving look ahead validity band size (A_{b}) at block 65, for example, as follows:

$$\begin{matrix}{A}_{vla} = \frac{{\sum }_{1}^{{Q}_{s}^{WA}} {WA}_{v}}{{Q}_{s}^{WA}} & [ Eq . 4 ] \\ {A}_{b} = \frac{{\sum }_{1}^{N} {WA}_{ab s}}{{Q}_{s}^{WA}} & [ Eq . 5 ]\end{matrix}$$

Otherwise, for an average case with more than minimum queue size entries in the write amplification queue at block 62, the method 60 may then include recalculating the average moving look ahead validity (Aᵥₗₐ), average moving look ahead validity band size (A_{b}) at block 65, for example, as follows:

$$\begin{matrix}{A}_{vla} = {\sum }_{1}^{{Q}_{s}^{WA}} \frac{{WA}_{v}}{{2}^{{Q}_{s}^{WA}}} & [ Eq . 6 ] \\ {A}_{b} = {\sum }_{1}^{{Q}_{s}^{WA}} \frac{{WA}_{ab s}}{{Q}_{s}^{WA}} & [ Eq . 7 ]\end{matrix}$$

After block 65, the method 60 may then proceed to determining if the number of entries in a dust queue is greater than or equal to a threshold at block 66. If so, the method 60 may include recalculating the average moving look ahead validity (Aᵥₗₐ), average moving look ahead validity band size (A_{b}) at block 67, for example, as follows (e.g., where K≥Qₛ^{DU}, and where L=Qₛ^{DU}−Qₛ^{WA}):

$$\begin{matrix}{A}_{vla} = \frac{{\sum }_{1}^{{Q}_{s}^{WA}} {WA}_{v} + {\sum }_{1}^{L} {DU}_{v}}{{Q}_{s}^{WA} + L} & [ Eq . 8 ] \\ {A}_{b} = \frac{{\sum }_{1}^{{Q}_{s}^{WA}} {WA}_{ab s} + {\sum }_{1}^{L} {WA}_{ab s}}{{Q}_{s}^{WA} + L} & [ Eq . 9 ]\end{matrix}$$

After block 67, the method 60 may then proceed to determining if the median dust validity is not equal to zero at block 68 (e.g., DUᵥ(Median) <>0). If so, the method 60 may then include recalculating the average moving look ahead validity (Aᵥₗₐ), and determining an average moving look ahead validity slow (Aᵥₗₐₛ) at block 69, for example, as follows:

$$\begin{matrix}{A}_{val}^{d} = {\sum }_{1}^{N} \frac{{DU}_{a bs}}{N} & [ Eq . 10 ] \\ {A}_{vla} = {A}_{vla} - \frac{{A}_{vla} * {DU}_{v} ( Median )}{{Q}_{s}^{WA}} + \frac{{A}_{val}^{d} * {DU}_{v} ( Median )}{{Q}_{s}^{WA}} & [ Eq . 11 ] \\ {A}_{vla} = {A}_{b} - {A}_{vla} & [ Eq . 12 ] \\ {A}_{vlas} = {A}_{vlas} - \frac{{A}_{vlas}}{minimum ( {Q}_{s}^{WA} , {Q}_{s}^{DU} )} + \frac{{A}_{vla}}{minimum ( {Q}_{s}^{WA} , {Q}_{s}^{DU} )} & [ Eq . 13 ]\end{matrix}$$

Some embodiments of the method 60 may be continuous based on the time series of PB and/or EB updates to the blocks. In the update mechanism, the window of evaluation may be limited to the highest contributors contained with an ordered set referred to as a queue or a look ahead queue. The system perspective of statistical sample significance may be driven by the band element. For some embodiments, a collective set of sets may be created from the {DU, FR WA} queues.

Advantageously, some embodiments may allow the current valid content to be taken into account with the ratio to actual non-defective blocks, improving adaptive garbage selection technology to choose a better or optimized candidate given the current state of the media. Some embodiments may advantageously provide uniform wearing of bands, resulting in lower maximum concurrency variance (e.g., due to selection of otherwise less-optimal bands). Moreover, the bounded behavior of some embodiments may lead to more predictable behavior in cloud computing environments. More predictable behavior may in turn help ensure resource (e.g., host bandwidth) demand may be met for more use cases.

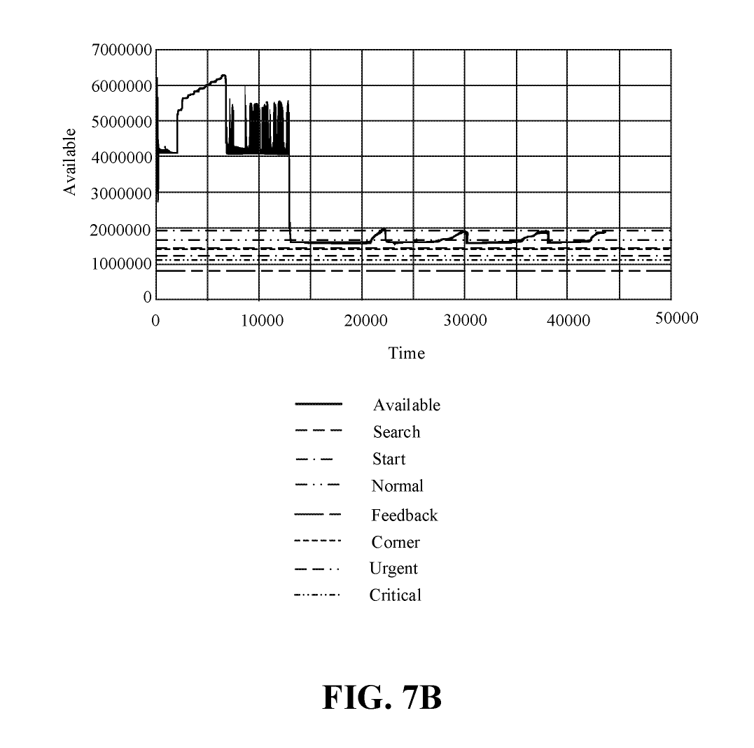

Turning now to FIGS. 7A to 7B, illustrative graphs of available blocks versus time show a first GC system which selects a reclaim unit based on average free space and invalid content information only (FIG. 7A), and an embodiment of a second GC system which further selects the reclaim unit based on average valid content information (FIG. 7B). A comparison of FIG. 7A versus FIG. 7B illustrates an example improvement in free space management in accordance with the embodiment of the second GC system.

As shown in FIG. 7A, there are non-uniform drops in free space around time locations 20000 and 35000 resulting in system resources being allocated towards garbage collection, away from host activity, and lowering host performance. For example, the decreases in available blocks may be due to defects in the reclaim unit(s) selected, leading to unpredictable performance uniformity in cloud computing workloads for the first GC system. FIG. 7B illustrates an example of free space maintaining between start and normal asymptotes. The bounded behavior of the second GC system may advantageously lead to more predictable performance in cloud computing environments. More predictable performance in turn helps ensure resource (e.g., host bandwidth) demand can be met for more use cases.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

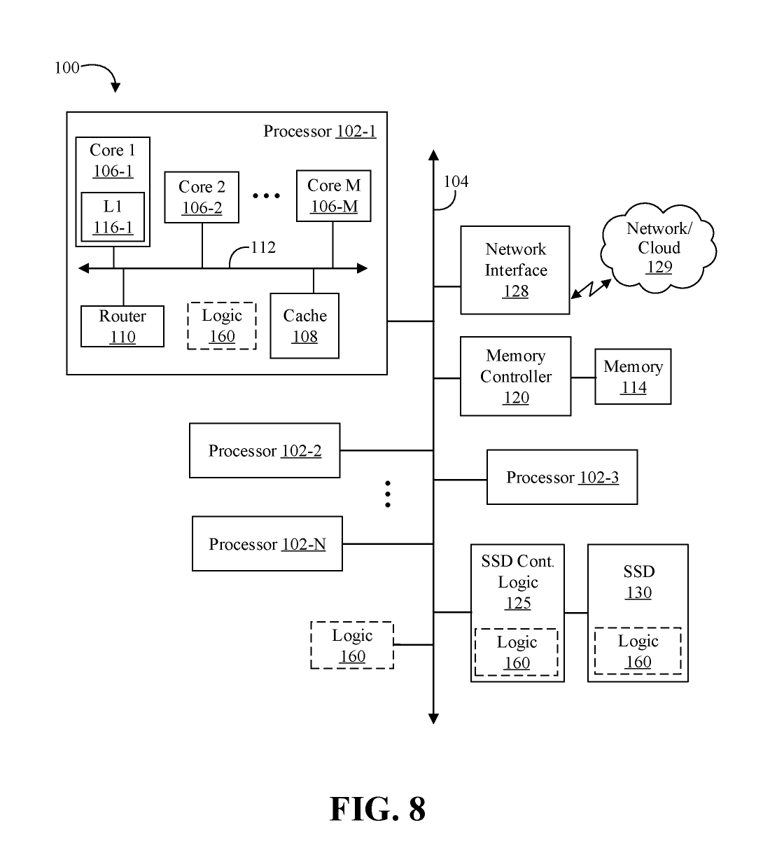

Turning now to FIG. 8, an embodiment of a computing system 100 may include one or more processors 102-1 through 102-N (generally referred to herein as “processors 102” or “processor 102”). The processors 102 may communicate via an interconnection or bus 104. Each processor 102 may include various components some of which are only discussed with reference to processor 102-1 for clarity. Accordingly, each of the remaining processors 102-2 through 102-N may include the same or similar components discussed with reference to the processor 102-1.

In some embodiments, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 160, memory controllers, or other components.

In some embodiments, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102. As shown in FIG. 8, the memory 114 may be in communication with the processors 102 via the interconnection 104. In some embodiments, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

As shown in FIG. 8, memory 114 may be coupled to other components of system 100 through a memory controller 120. Memory 114 includes volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

The system 100 may communicate with other devices/systems/networks via a network interface 128 (e.g., which is in communication with a computer network and/or the cloud 129 via a wired or wireless interface). For example, the network interface 128 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 129.

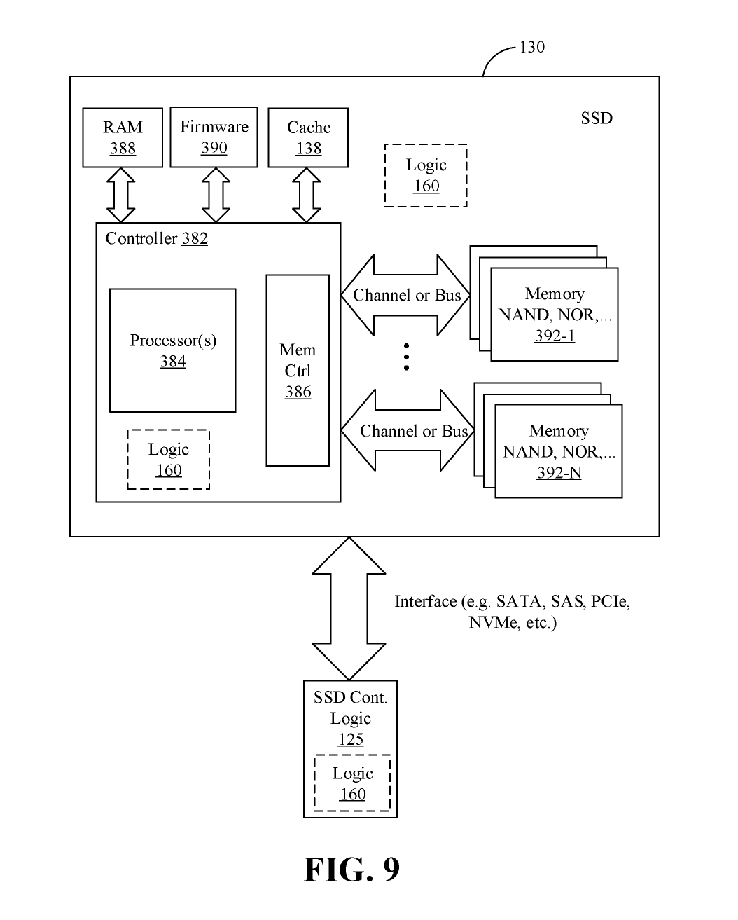

System 100 may also include Non-Volatile (NV) storage device such as a SSD 130 coupled to the interconnect 104 via SSD controller logic 125. Hence, logic 125 may control access by various components of system 100 to the SSD 130. Furthermore, even though logic 125 is shown to be directly coupled to the interconnection 104 in FIG. 8, logic 125 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), etc.) with one or more other components of system 100 (for example where the storage bus is coupled to interconnect 104 via some other logic like a bus bridge, chipset, etc. (such as discussed with reference to FIGS. 1-2, 5, and 9). Additionally, logic 125 may be incorporated into memory controller logic (such as those discussed with reference to FIG. 9) or provided on a same integrated circuit (IC) device in various embodiments (e.g., on the same IC device as the SSD 130 or in the same enclosure as the SSD 130).

Furthermore, logic 125 and/or SSD 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein such as those discussed with reference to other figures including FIGS. 1-2, 5, and 9, for example), including the cores 106, interconnections 104 or 112, components outside of the processor 102, SSD 130, SSD bus, SATA bus, logic 125, logic 160, etc., to sense variations in various factors affecting power/thermal behavior of the system/platform, such as temperature, operating frequency, operating voltage, power consumption, and/or inter-core communication activity, etc.

As illustrated in FIG. 8, SSD 130 may include logic 160, which may be in the same enclosure as the SSD 130 and/or fully integrated on a printed circuit board (PCB) of the SSD 130. Logic 160 provides technology to quickly adapt garbage collection resource allocation for an incoming input/output (I/O) workload as discussed herein (e.g., with reference to FIGS. 7A to 7B). More particularly, forward moving average validity (FMAV) technology may allow garbage collection to adapt its resources to changing workloads much faster; therefore, reducing the number of bands it requires. This in turn translates to more effective spare, better performance, and longer SSD life. For example, garbage collection utilizing FMAV technology may examine the state of bands that are candidates for garbage collection instead of the state of bands that have just been processed. By examining the amount of valid data in the candidate bands, garbage collection has a better representation of the required resources for the incoming workload and can adapt its resource allocation faster.

Advantageously, the logic 160 may also implement one or more aspects of the method 24 (FIGS. 3A to 3C), the method 40 (FIG. 4), and/or the method 60 (FIG. 6). For example, the logic 160 may further include technology to track defect information related to the SSD 130, and determine a best next reclaim unit candidate for GC based on the tracked defect information. In some embodiments, the logic 160 may be configured to store the tracked defect information in the cache 108 (e.g., or some other cache in the system 100). In some embodiments, the logic 160 may be further configured to determine average invalid content information for the SSD 130, determine free space information for the SSD 130, determine average valid content information for the SSD 130 based at least in part on the tracked defect information, and determine the best next reclaim unit candidate for GC based on the determined average invalid content information, the determined free space information, and the determined average valid content information. For example, the logic 160 may be configured to determine the best next reclaim unit candidate for GC based on a ratio of the determined average invalid content information to the determined average valid content information.

In some embodiments, the logic 160 may be further configured to allocate resources between a host and GC based on the determined average invalid content information, the determined free space information, and the determined average valid content information. The logic 160 may additionally, or alternatively, be configured to select the determined best next reclaim unit candidate as a reclaim unit for GC, and move content from the reclaim unit to a new, destination reclaim unit on the SSD 130. In other embodiments, the SSD 130 may be replaced with any suitable persistent storage technology/media. In some embodiments, the logic 160 may be coupled to one or more substrates (e.g., silicon, sapphire, gallium arsenide, PCB, etc.), and may include transistor channel regions that are positioned within the one or more substrates. As shown in FIG. 8, features or aspects of the logic 160 may be distributed throughout the system 100, and/or co-located/integrated with various components of the system 100.

FIG. 9 illustrates a block diagram of various components of the SSD 130, according to an embodiment. As illustrated in FIG. 9, logic 160 may be located in various locations such as inside the SSD 130 or controller 382, etc., and may include similar technology as discussed in connection with FIG. 8. SSD 130 includes a controller 382 (which in turn includes one or more processor cores or processors 384 and memory controller logic 386), cache 138, RAM 388, firmware storage 390, and one or more memory modules or dies 392-1 to 392-N (which may include NAND flash, NOR flash, or other types of non-volatile memory). In some embodiments, the logic 160 may be configured to store tracked defect information in the cache 138. Memory modules 392-1 to 392-N are coupled to the memory controller logic 386 via one or more memory channels or busses. Also, SSD 130 communicates with logic 125 via an interface (such as a SATA, SAS, PCIe, NVMe, etc., interface). One or more of the features/aspects/operations discussed with reference to FIGS. 1-8 may be performed by one or more of the components of FIG. 9. Processors 384 and/or controller 382 may compress/decompress (or otherwise cause compression/decompression) of data written to or read from memory modules 392-1 to 392-N. Also, one or more of the features/aspects/operations of FIGS. 1-8 may be programmed into the firmware 390. Further, SSD controller logic 125 may include logic 160.

### ADDITIONAL NOTES AND EXAMPLES

Example 1 may include an electronic processing system, comprising persistent storage media, and a storage controller communicatively coupled to the persistent storage media, wherein the storage controller includes logic to track defect information related to the persistent storage media, and determine a best next candidate for background clean-up of the persistent storage media based on the tracked defect information.

Example 2 may include the system of Example 1, wherein the logic is further to store the tracked defect information in a cache.

Example 3 may include the system of Example 1, wherein the logic is further to determine average invalid content information for the persistent storage media, determine free space information for the persistent storage media, determine average valid content information for the persistent storage media based at least in part on the tracked defect information, and determine the best next candidate for background clean-up of the persistent storage media based on the determined average invalid content information, the determined free space information, and the determined average valid content information.

Example 4 may include the system of Example 3, wherein the logic is further to determine the best next candidate for background clean-up of the persistent storage media based on a ratio of the determined average invalid content information to the determined average valid content information.

Example 5 may include the system of Example 3, wherein the logic is further to allocate resources between a host and the background clean-up based on the determined average invalid content information, the determined free space information, and the determined average valid content information.

Example 6 may include the system of Example 5, wherein the logic is further to select the determined best next candidate as a reclaim unit for background clean-up, and move content from the reclaim unit to a new destination on the persistent storage media.

Example 7 may include the system of any of Examples 1 to 6, wherein the persistent storage media comprises a solid state drive.

Example 8 may include a semiconductor apparatus, comprising one or more substrates, and logic coupled to the one or more substrates, wherein the logic is at least partly implemented in one or more of configurable logic and fixed-functionality hardware logic, the logic coupled to the one or more substrates to track defect information related to a persistent storage media, and determine a best next candidate for background clean-up of the persistent storage media based on the tracked defect information.

Example 9 may include the apparatus of Example 8, wherein the logic is further to store the tracked defect information in a cache.

Example 10 may include the apparatus of Example 8, wherein the logic is further to determine average invalid content information for the persistent storage media, determine free space information for the persistent storage media, determine average valid content information for the persistent storage media based at least in part on the tracked defect information, and determine the best next candidate for background clean-up of the persistent storage media based on the determined average invalid content information, the determined free space information, and the determined average valid content information.

Example 11 may include the apparatus of Example 10, wherein the logic is further to determine the best next candidate for background clean-up of the persistent storage media based on a ratio of the determined average invalid content information to the determined average valid content information.

Example 12 may include the apparatus of Example 10, wherein the logic is further to allocate resources between a host and the background clean-up based on the determined average invalid content information, the determined free space information, and the determined average valid content information.

Example 13 may include the apparatus of Example 12, wherein the logic is further to select the determined best next candidate as a reclaim unit for background clean-up, and move content from the reclaim unit to a new destination on the persistent storage media.

Example 14 may include the apparatus of any of Examples 8 to 13, wherein the logic coupled to the one or more substrates includes transistor channel regions that are positioned within the one or more substrates.

Example 15 may include a method of controlling storage, comprising tracking defect information related to a persistent storage media, and determining a best next candidate for background clean-up of the persistent storage media based on the tracked defect information.

Example 16 may include the method of Example 15, further comprising storing the tracked defect information in a cache.

Example 17 may include the method of Example 15, further comprising determining average invalid content information for the persistent storage media, determining free space information for the persistent storage media, determining average valid content information for the persistent storage media based at least in part on the tracked defect information, and determining the best next candidate for background clean-up of the persistent storage media based on the determined average invalid content information, the determined free space information, and the determined average valid content information.

Example 18 may include the method of Example 17, further comprising determining the best next candidate for background clean-up of the persistent storage media based on a ratio of the determined average invalid content information to the determined average valid content information.

Example 19 may include the method of Example 17, further comprising allocating resources between a host and the background clean-up based on the determined average invalid content information, the determined free space information, and the determined average valid content information.

Example 20 may include the method of Example 19, further comprising selecting the determined best next candidate as a reclaim unit for background clean-up, and moving content from the reclaim unit to a new destination on the persistent storage media.

Example 21 may include the method of any of Examples 15 to 20, wherein the persistent storage media comprises a solid state drive.

Example 22 may include the apparatus of any of Examples 8 to 14, wherein the persistent storage media comprises a solid state drive.

Example 23 may include at least one computer readable storage medium, comprising a set of instructions, which when executed by a computing device, cause the computing device to track defect information related to a persistent storage media, and determine a best next candidate for background clean-up of the persistent storage media based on the tracked defect information.

Example 24 may include the at least one computer readable storage medium of Example 23, comprising a further set of instructions, which when executed by the computing device, cause the computing device to store the tracked defect information in a cache.

Example 25 may include the at least one computer readable storage medium of Example 23, comprising a further set of instructions, which when executed by the computing device, cause the computing device to determine average invalid content information for the persistent storage media, determine free space information for the persistent storage media, determine average valid content information for the persistent storage media based at least in part on the tracked defect information, and determine the best next candidate for background clean-up of the persistent storage media based on the determined average invalid content information, the determined free space information, and the determined average valid content information.

Example 26 may include the at least one computer readable storage medium of Example 25, comprising a further set of instructions, which when executed by the computing device, cause the computing device to determine the best next candidate for background clean-up of the persistent storage media based on a ratio of the determined average invalid content information to the determined average valid content information.

Example 27 may include the at least one computer readable storage medium of Example 25, comprising a further set of instructions, which when executed by the computing device, cause the computing device to allocate resources between a host and the background clean-up based on the determined average invalid content information, the determined free space information, and the determined average valid content information.

Example 28 may include the at least one computer readable storage medium of Example 27, comprising a further set of instructions, which when executed by the computing device, cause the computing device to select the determined best next candidate as a reclaim unit for background clean-up, and move content from the reclaim unit to a new destination on the persistent storage media.

Example 29 may include the at least one computer readable storage medium of any of Examples 23 to 28, wherein the persistent storage media comprises a solid state drive.

Example 30 may include a storage controller apparatus, comprising means for tracking defect information related to a persistent storage media, and means for determining a best next candidate for background clean-up of the persistent storage media based on the tracked defect information.

Example 31 may include the apparatus of Example 30, further comprising means for storing the tracked defect information in a cache.

Example 32 may include the apparatus of Example 30, further comprising means for determining average invalid content information for the persistent storage media, means for determining free space information for the persistent storage media, means for determining average valid content information for the persistent storage media based at least in part on the tracked defect information, and means for determining the best next candidate for background clean-up of the persistent storage media based on the determined average invalid content information, the determined free space information, and the determined average valid content information.

Example 33 may include the apparatus of Example 32, further comprising means for determining the best next candidate for background clean-up of the persistent storage media based on a ratio of the determined average invalid content information to the determined average valid content information.

Example 34 may include the apparatus of Example 32, further comprising means for allocating resources between a host and the background clean-up based on the determined average invalid content information, the determined free space information, and the determined average valid content information.

Example 35 may include the apparatus of Example 34, further comprising means for selecting the determined best next candidate as a reclaim unit for background clean-up, and means for moving content from the reclaim unit to a new destination on the persistent storage media.

Example 36 may include the apparatus of any of Examples 30 to 35, wherein the persistent storage media comprises a solid state drive.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. the description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
persistent storage media; and
a storage controller communicatively coupled to the persistent storage media, wherein the storage controller includes logic to:
track defect information related to the persistent storage media, and
determine a best next candidate for background clean-up of the persistent storage media based on the tracked defect information.

2. The system of claim 1, wherein the logic is further to:
store the tracked defect information in a cache.

3. The system of claim 1, wherein the logic is further to:
determine average invalid content information for the persistent storage media;
determine free space information for the persistent storage media;
determine average valid content information for the persistent storage media based at least in part on the tracked defect information; and
determine the best next candidate for background clean-up of the persistent storage media based on the determined average invalid content information, the determined free space information, and the determined average valid content information.

4. The system of claim 3, wherein the logic is further to:
determine the best next candidate for background clean-up of the persistent storage media based on a ratio of the determined average invalid content information to the determined average valid content information.

5. The system of claim 3, wherein the logic is further to:
allocate resources between a host and the background clean-up based on the determined average invalid content information, the determined free space information, and the determined average valid content information.

6. The system of claim 5, wherein the logic is further to:
select the determined best next candidate as a reclaim unit for background clean-up; and
move content from the reclaim unit to a new destination on the persistent storage media.

7. The system of claim 1, wherein the persistent storage media comprises a solid state drive.

8. A semiconductor apparatus, comprising:
one or more substrates; and
logic coupled to the one or more substrates, wherein the logic is at least partly implemented in one or more of configurable logic and fixed-functionality hardware logic, the logic coupled to the one or more substrates to:
track defect information related to a persistent storage media, and
determine a best next candidate for background clean-up of the persistent storage media based on the tracked defect information.

9. The apparatus of claim 8, wherein the logic is further to:
store the tracked defect information in a cache.

10. The apparatus of claim 8, wherein the logic is further to:
determine average invalid content information for the persistent storage media;
determine free space information for the persistent storage media;
determine average valid content information for the persistent storage media based at least in part on the tracked defect information; and
determine the best next candidate for background clean-up of the persistent storage media based on the determined average invalid content information, the determined free space information, and the determined average valid content information.

11. The apparatus of claim 10, wherein the logic is further to:
determine the best next candidate for background clean-up of the persistent storage media based on a ratio of the determined average invalid content information to the determined average valid content information.

12. The apparatus of claim 10, wherein the logic is further to:
allocate resources between a host and the background clean-up based on the determined average invalid content information, the determined free space information, and the determined average valid content information.

13. The apparatus of claim 12, wherein the logic is further to:
select the determined best next candidate as a reclaim unit for background clean-up; and
move content from the reclaim unit to a new destination on the persistent storage media.

14. The apparatus of claim 8, wherein the logic coupled to the one or more substrates includes transistor channel regions that are positioned within the one or more substrates.

15. A method of controlling storage, comprising:
tracking defect information related to a persistent storage media; and
determining a best next candidate for background clean-up of the persistent storage media based on the tracked defect information.

16. The method of claim 15, further comprising:
storing the tracked defect information in a cache.

17. The method of claim 15, further comprising:
determining average invalid content information for the persistent storage media;
determining free space information for the persistent storage media;
determining average valid content information for the persistent storage media based at least in part on the tracked defect information; and
determining the best next candidate for background clean-up of the persistent storage media based on the determined average invalid content information, the determined free space information, and the determined average valid content information.

18. The method of claim 17, further comprising:
determining the best next candidate for background clean-up of the persistent storage media based on a ratio of the determined average invalid content information to the determined average valid content information.

19. The method of claim 17, further comprising:
allocating resources between a host and the background clean-up based on the determined average invalid content information, the determined free space information, and the determined average valid content information.

20. The method of claim 19, further comprising:
selecting the determined best next candidate as a reclaim unit for background clean-up; and
moving content from the reclaim unit to a new destination on the persistent storage media.
